(19) United States
(12) Patent Application Publication
(10) Pub. No.: US 2012/0239236 A1
(43) Pub. Date: Sep. 20, 2012

(54) ELECTRIC CAR AND CONTROL METHOD THEREOF

(75) Inventor: Ki Tae Eom, Bucheon-Si (KR)

(73) Assignee: V-ENS CO., LTD, INCHEON (KR)

(21) Appl. No.: 13/505,400

(22) PCT Filed: Nov. 1, 2010
(86) PCT No.: PCT/KR10/07578

§ 371 Date: May 29, 2012

(30) Foreign Application Priority Data
Nov. 3, 2009 (KR) 10-2009-00105598
Aug. 2, 2010 (KR) 10-2010-0074746

(51) Int. Cl. B60L 15/20

(52) U.S. Cl. 701/22

(57) ABSTRACT

The present invention relates to an electric car which has a battery pack at a constant state of maximum power discharge and to a method of efficiently controlling a motor with due consideration for rechargeable power levels. The control method according to one embodiment of the present invention, comprises the steps of: calculating estimated power levels required, based on current power consumption levels, for providing current from the battery pack to all parts of an electric car, and the required torque according to a driver's activation of the accelerator; comparing the estimated power levels required with the maximum possible power discharge from the battery pack; and enabling maximum possible torque from the motor when the estimated power levels required exceeds the current maximum possible power discharge from the battery pack.

### TECHNICAL FIELD

The present invention relates to an electric vehicle and a control method thereof, and more particularly, to an electric vehicle and a control method thereof, which achieve efficient control of a motor in consideration of the state of a battery pack.

### BACKGROUND ART

Electric vehicles have been actively studied because they are the most promising alternative capable of solving pollution and energy problems in the future.

Electric vehicles (EV) are mainly powered by driving an AC or DC motor using power of a battery. The electric vehicles are broadly classified into battery powered electric vehicles and hybrid electric vehicles. In the battery powered electric vehicles, a motor is driven using power of a battery, and the battery is rechargeable after the stored power is completely consumed. In the hybrid electric vehicles, a battery is charged with electricity generated via engine driving, and an electric motor is driven using the electricity to realize vehicle movement.

The hybrid electric vehicles may further be classified into serial type ones and parallel type ones. In the case of serial hybrid electric vehicles, mechanical energy output from an engine is changed into electric energy via a generator, and the electric energy is fed to a battery or motor. Thus, the serial hybrid electric vehicles are always driven by a motor similar to conventional electric vehicles, but an engine and generator are added for the purpose of increasing a traveling range. Parallel hybrid electric vehicles may be driven using two power sources, i.e. a battery and an engine (gasoline or diesel). Also, the parallel hybrid electric vehicles may be driven using both the engine and the motor according to traveling conditions.

With recent gradual development of motor/control technologies, small high-output and high-efficiency systems have been developed. Owing to replacing a DC motor by an AC motor, electric vehicles have accomplished considerably enhanced output and power performance (acceleration performance and maximum speed) comparable to those of gasoline vehicles. As a result of promoting a higher output and higher revolutions per minute, a motor has achieved reduction in weight and size, and consequently reduction in the weight and size of a vehicle provided with the motor.

### DISCLOSURE

### Technical Problem

Therefore, the present invention has been made in view of the above problems, and it is an object of the present invention to provide an electric vehicle and a control method thereof, which achieve efficient control of a motor in consideration of a maximum dischargeable or rechargeable power level of a battery pack.

It is another object of the present invention to provide a motor torque control method, in which a motor is controlled based on the state of a battery provided in an the electric vehicle in such a way that accurate torque control can be performed by reflecting a weighted torque value based on each sensor value causing one-sided torque output upon calculation of a torque value of the motor, resulting in improvement in traveling at high speeds.

Objects of the present invention are not limited to the above described objects, and those skilled in the art will clearly understand other not mentioned objects from the following description.

### Technical Solution

In accordance with one aspect of the present invention, the above and other objects can be accomplished by the provision of a control method of an electric vehicle, including calculating an estimated required power level from a request torque value obtained when a driver operates an accelerator and a currently consumed power level discharged from a battery pack to each element of the electric vehicle, comparing the estimated required power level with a maximum dischargeable power level of the battery pack, and calculating a possible maximum torque value from the maximum dischargeable power level if the estimated required power level is greater than the maximum dischargeable power level, to drive a motor by the possible maximum torque value.

In accordance with another aspect of the present invention, there is provided a control method of an electric vehicle, including calculating an estimated charge power level from a request torque value obtained when a driver operates a brake and a currently consumed power level discharged from a battery pack to each element of the electric vehicle, comparing the estimated charge power level with a maximum rechargeable power level of the battery pack, and calculating a possible maximum torque value from the maximum rechargeable power level if the estimated charge power level is greater than the maximum rechargeable power level, to allow a motor to charge the battery pack by the possible maximum torque value

In accordance with another aspect of the present invention, there is provided a motor torque control method of an electric vehicle, including calculating a request torque value based on acceleration information, braking information, and a vehicle speed, determining an allowable maximum torque value with respect to the request torque value based on a residual power quantity and voltage of a battery, calculating a corrected torque value by applying a weighted torque value based on an one-side torque output factor to the allowable maximum torque value when one-sided torque output occurs, and controlling a motor using a final torque value that is calculated by changing the corrected torque value and a current torque value used for motor control based on a preset rate.

In accordance with another aspect of the present invention, there is provided an electric vehicle including an interface unit including an accelerator sensor to output acceleration information as a driver operates an accelerator, and a brake sensor to output braking information as the driver operates a brake, a battery pack to discharge electric power, a vehicle control module for calculating an estimated required power level from a request torque value based on the acceleration information and a currently consumed power level discharged from the battery pack, and comparing the estimated required power level with a maximum dischargeable power level of the battery pack, and a motor to be driven a possible maximum torque value that is calculated from the maximum dischargeable power level by the vehicle control module if the estimated required power level is greater than the maximum dischargeable power level.

In accordance with a further aspect of the present invention, there is provided an electric vehicle including an interface unit to output braking information as a driver operates a brake, a battery pack to discharge electric power, a vehicle control module for calculating an estimated charge power level from a request torque value based on the braking information and a currently consumed power level discharged from the battery pack, and comparing the estimated charge power level with a maximum rechargeable power level of the battery pack, and a motor to charge the battery pack by a possible maximum torque value that is calculated from the maximum rechargeable power level by the vehicle control module if the estimated charge power level is greater than the maximum rechargeable power level.

### Advantageous Effects

An electric vehicle and a control method thereof according to the present invention have one or more effects as follows.

Firstly, owing to control of a motor using a torque value acquired in consideration of a maximum dischargeable power level of a battery pack, it is possible to advantageously extend the lifespan of the battery pack beyond a warranty.

Secondly, owing to control of a motor using a counter torque value acquired in consideration of a maximum rechargeable power level of a battery pack, it is possible to advantageously extend the lifespan of the battery pack beyond a warranty.

Thirdly, owing to not only limiting torque in consideration of a charged state of the battery pack, but also performing accurate torque control by reflecting a weighted torque value based on each sensor value causing one-sided torque output, improvement in traveling performance can be achieved.

Effects of the present invention are not limited to the above described effects, and those skilled in the art will clearly understand other not mentioned effects from the description of Claims.

### DESCRIPTION OF DRAWINGS

FIG. 1 is a block diagram illustrating an electric vehicle according to a first embodiment of the present invention;

FIG. 2 is a flowchart illustrating a control method of the electric vehicle according to one embodiment of the present invention;

FIG. 3 is a flowchart illustrating a control method of the electric vehicle according to another embodiment of the present invention;

FIG. 4 is a block diagram illustrating a control configuration of the electric vehicle according to a further embodiment of the present invention; and

FIG. 5 is a flowchart illustrating a control method of the electric vehicle in FIG. 4.

### BEST MODE

The advantages and features of the present invention and the way of attaining them will become apparent with reference to embodiments described below in detail in conjunction with the accompanying drawings. Embodiments, however, may be embodied in many different forms and should not be constructed as being limited to example embodiments set forth herein. Rather, these example embodiments are provided so that this disclosure will be through and complete and will fully convey the scope to those skilled in the art. The scope of the present invention should be defined by the claims.

Wherever possible, the same reference numbers will be used throughout the drawings to refer to the same or like parts.

Hereinafter, an electric vehicle and a control method thereof according to the exemplary embodiments of the present invention will be described with reference to the accompanying drawings.

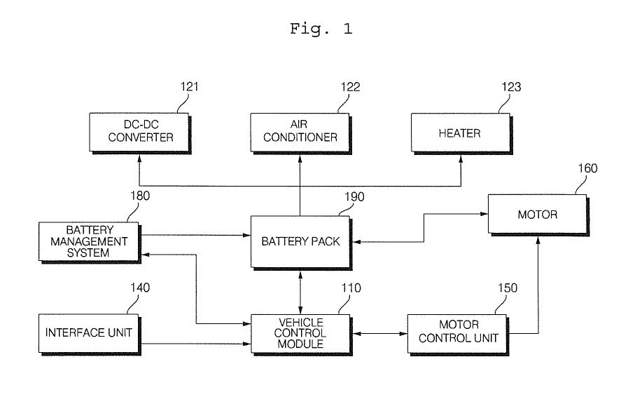

FIG. 1 is a block diagram illustrating an electric vehicle according to an embodiment of the present invention.

The electric vehicle according to the embodiment of the present invention includes an interface unit 140, a battery management system 180, a battery pack 190, a vehicle control module 110, a motor control unit 150, and a motor 160.

The interface unit 140 includes an input device to input predetermined signals via operation of a driver, and an output device to output information on the current operating state of the electric vehicle to the outside.

The input device includes an operating device, such as a steering wheel, an accelerator, and a brake. The accelerator outputs acceleration information to the vehicle control module 110 via operation of the driver. The brake outputs braking information to the vehicle control module 110 via operation of the driver.

Additionally, the input device includes, for example, a plurality of switches and buttons for operation of a turn signal, a tail lamp, a head lamp, and a windshield wiper brush during traveling.

The output device includes a display device to display information, a speaker to output sound effects and an alarm sound, and other state informing devices.

The battery pack 190 includes a plurality of batteries, and is charged or discharged with electric power (electric current). The battery pack 190 discharges electric power to respective constituent elements of the electric vehicle including, for example, a DC-DC converter 121, an air conditioner 122, a heater 123, and the motor 160. Also, the battery pack 190 is charged with electric power from an external power source (not shown) or the motor 160.

The battery management system (EMS) 180 outputs variety of information on the battery pack 190, such as a battery voltage, current, charged power quantity, maximum dischargeable power level, maximum rechargeable power level, and the like, to the vehicle control module 110, for efficient management of the battery pack 190. The battery management system 180 serves to manage supply of electric power stored in the battery pack 190 to the respective constituent elements of the electric vehicle, such as the DC-DC converter 121, the air conditioner 122, the heater 123, the motor 160, and the like.

The DC-DC converter 121 serves to amplify DC power and perform DC-DC conversion. The air conditioner 122 serves to cool the interior of the electric vehicle, and the heater 123 serves to heat the interior of the electric vehicle.

The battery management system 180 maintains a constant voltage difference between cells within the battery upon charge or discharge of the battery, thereby preventing excessive charge or excessive discharge of the battery.

The motor control unit (MCU) 150 serves to control the motor 160 by producing control signals to drive the motor 160. In this case, the motor control unit 150 may control driving of the motor 160 as the motor driving control signals produced by the motor control unit 150 are used to control an inverter (not shown) and a converter (not shown) included in the motor drive unit. The motor control unit 160 may also control the motor 160 upon receiving a torque value output from the vehicle control module 110.

The motor control unit 150 may also control the motor 160 such that the battery pack 190 is charged with electric power of the motor 160. When the output of the motor 160 is reduced due to, for example, braking operation, the motor control unit generates counter torque of the motor 160, thereby allowing the battery pack 190 to be charged with electric power of the motor. A value of the generated counter torque is output from the vehicle control module 110.

During driving of the motor 160, the motor control unit 150 may output a currently applied torque value of the motor 160 to the vehicle control module 110.

The motor 160 is able to generate rotational power required to move the electric vehicle. The output of the motor 160 is adjustable under control of the motor control unit 150 as the driver operates the accelerator or the brake of the interface unit 140. The torque of the motor 160 is generated by electric power discharged from the battery pack 190. Also, when the counter torque of the motor 160 is generated, the battery pack 190 may be charged with electric power of the motor.

The vehicle control module (VCM) 110 serves to control general operations and traveling of the electric vehicle. To this end, the vehicle control module 110 may output a torque value to the motor control unit 150 to enable implementation of a preset operation in response to signals input from the interface unit 140. The vehicle control module 110 also controls input and output of data. In addition, the vehicle control unit 110 serves to manage the battery pack 190 in cooperation with the battery management system 180.

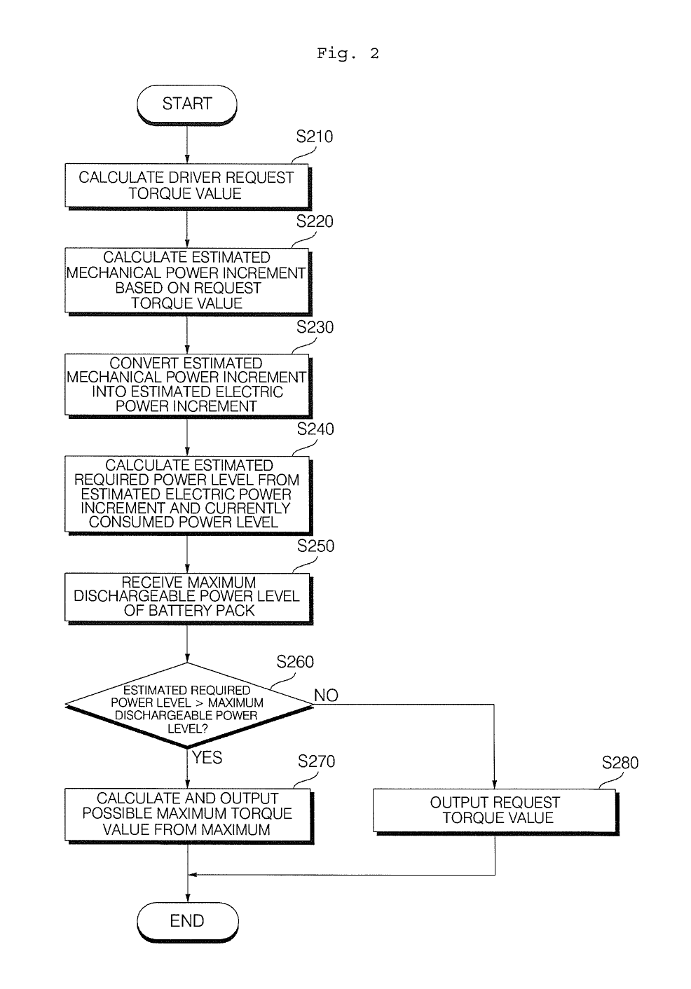

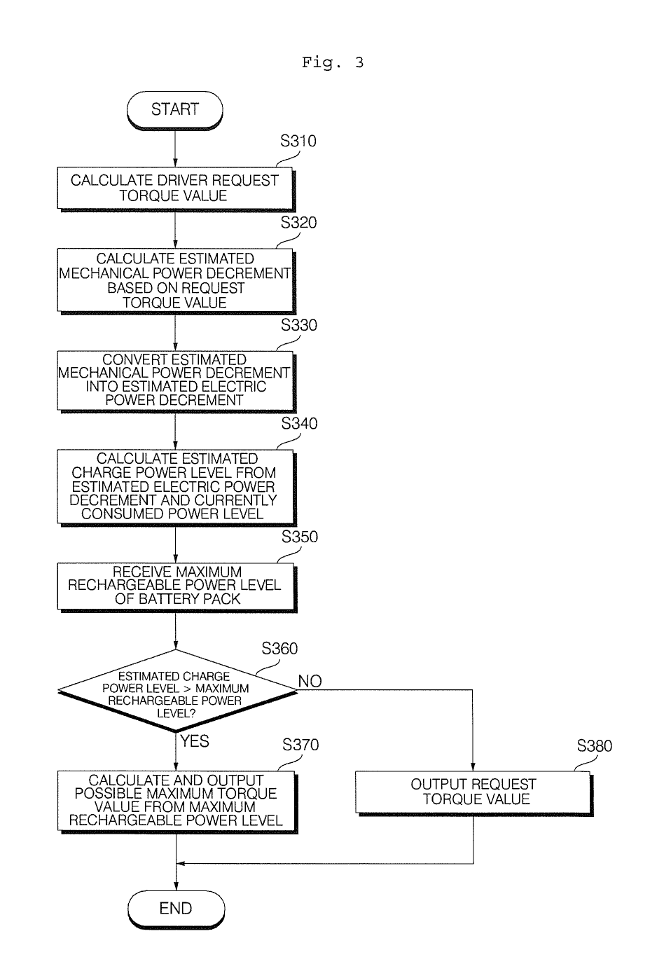

Hereinafter, a control method of the electric vehicle will be described in detail with reference to FIGS. 2 and 3.

FIG. 2 is a flowchart illustrating a control method of the electric vehicle according to one embodiment of the present invention.

If the driver steps on the accelerator of the interface unit 140, acceleration information is input to the vehicle control module 110. The vehicle control module 110 calculates a driver request torque value from the acceleration information (S210). The vehicle control module 110 may calculate the driver request torque value based on the acceleration information using, for example, a look-up table.

The vehicle control module 110 calculates an estimated mechanical power increment based on the driver request torque value (S220). More specifically, the vehicle control module 110 calculates the estimated mechanical power increment from the calculated driver request torque value and a currently applied torque value output from the motor control unit 150.

A relationship between power P and torque T is represented by P=T*ω (here, “ω” is angular velocity). Since ω=2*π*n/60 assuming that revolutions per minute is “n” (rpm), P(ω)=T*(2*π*n/60)=0.1047*T*n.

Accordingly, Estimated Mechanical Power Increment ΔP(ω)=0.1047*Motor RPM*(Driver Request Torque−Currently Applied Torque).

Next, the vehicle control module 110 converts the estimated mechanical power increment into an estimated electric power increment (S230). The vehicle control module 110 calculates the estimated electric power increment in consideration of the efficiency of the motor 160 and the motor control unit 150. Since the efficiency of the motor 160 and the motor control unit 150 may be changed based on the current RPM of the motor 160 and the currently applied torque value, the vehicle control module 110 may first determine a desired efficiency using a look-up table, and thereafter may calculate the estimated electric power increment as follows:

Estimated Electric Power Increment=Estimated Mechanical Power Increment/Efficiency.

Next, the vehicle control module 110 calculates an estimated required power level by adding the estimated electric power increment to a currently consumed power level (S240). The currently consumed power level corresponds to the level of electric power discharged from the battery pack 190 to the respective constituent elements of the electric vehicle including, for example, the DC-DC converter 121, the air conditioner 121, the heater 123, and the motor 160. The currently consumed power level may be calculated using voltage and current values of the battery pack 190 output from the battery management system 180 as follows:

Currently Consumed Power Level=Voltage of Battery pack 190*Current of Battery Pack 190.

In this way, the vehicle control module 110 calculates the estimated required power level as follows:

Estimated Required Power Level=Estimated Electric Power Increment Currently Consumed Power Level.

The vehicle control module 110 receives a maximum dischargeable power level of the battery pack 190 from the battery management system 180 (S250). The maximum dischargeable power level of the battery pack 190 is changed based on a charged power quantity within the battery or the lifespan of the battery. Therefore, the vehicle control module 110 receives the maximum dischargeable power level of the battery pack 190 that is measured in real time.

The vehicle control module 110 compares the estimated required power level with the maximum dischargeable power level (S260). The vehicle control module 110 judges whether or not the estimated required power level is greater than the maximum dischargeable power level.

If the estimated required power level is greater than the maximum dischargeable power level, the vehicle control module 110 calculates a possible maximum torque value to output the possible maximum torque value to the motor control unit 150 (S270). More specifically, if the estimated required power level is greater than the maximum dischargeable power level of the battery pack 190, the motor control unit 150 calculates the possible maximum torque value from the maximum dischargeable power level in reverse order of the above described calculation.

This is as follows:

Possible Electric Power Increment=Maximum Dischargeable Power Level Currently Consumed Power Level

Possible Mechanical Power Increment=Possible Electric Power Increment*Efficiency

Possible Maximum Torque={Possible Mechanical Power Increment/(0.1047*Motor RPM)}+Currently Applied Torque

The vehicle control module 110 outputs the calculated possible maximum torque value to the motor control unit 150, and the motor control unit 150 controls the motor 160 such that the motor 160 is driven by the possible maximum torque value. In this case, since the output of the motor may be reduced as much as the driver operates the accelerator, it is preferable that the vehicle control module 110 informs the driver via the output device of the interface unit 140 that the output of the motor 160 is limited.

If the estimated required power level is equal to or lower than the maximum dischargeable power level, the vehicle control module 110 outputs the request torque value to the motor control unit 150 (S280). The motor control unit 150 controls the motor 160 such that the motor 160 is driven by the request torque value.

FIG. 3 is a flowchart illustrating a control method of the electric vehicle according to another embodiment of the present invention.

If the driver steps on the brake of the interface unit 140, braking information is input into the vehicle control module 110, and the vehicle control module 110 calculates a driver request torque value from the braking information (S310). In this case, the driver request torque value is obtained based on the braking information of the brake, and thus is referred to as a counter torque value. That is, the required torque has a negative vector value, and the absolute value of the required torque has a positive value. The request torque is applied in an opposite direction of a currently applied torque. The vehicle control module 110 may calculate the driver request torque value based on the braking information using, for example, a look-up table.

Next, the vehicle control module 110 calculates an estimated mechanical power decrement based on the driver request torque value (S320). More specifically, the vehicle control module 110 calculates the estimated mechanical power decrement from the calculated driver request torque value and a currently applied torque value output from the motor control unit 150.

A relationship between power P and torque T is represented by P=T*ω(here, “ω” is angular velocity). Since ω=2*π*n/60 assuming that revolutions per minute is “n” (rpm), P(w)=T*(2*π*n/60)=0.1047*T*n.

Accordingly, Estimated Mechanical Power Decrement ΔP(ω)=0.1047*Motor RPM*(Currently Applied Torque−Driver Request Torque).

Next, the vehicle control module 110 converts the estimated mechanical power decrement into an estimated electric power decrement (S330). The vehicle control module 110 calculates the estimated electric power decrement in consideration of the efficiency of the motor 160 and the motor control unit 150. Since the efficiency of the motor 160 and the motor control unit 150 may be changed based on the current RPM of the motor 160 and the currently applied torque, the vehicle control module 110 may first determine a desired efficiency using a look-up table, and thereafter may calculate the estimated electric power decrement as follows:

Estimated Electric Power Decrement=Estimated Mechanical Power Decrement/Efficiency.

Next, the vehicle control module 110 calculates an estimated charge power level by subtracting a currently consumed power level from the estimated electric power decrement (S340). The currently consumed power level corresponds to the level of electric power discharged from the battery pack 190 to the respective constituent elements of the electric vehicle including, for example, the DC-DC converter 121, the air conditioner 121, the heater 123, and the motor 160. The currently consumed power level may be calculated using voltage and current values of the battery pack 190 output from the battery management system 180 as follows:

Currently Consumed Power Level=Voltage of Battery pack 190*Current of Battery Pack 190.

In this way, the vehicle control module 110 calculates the estimated charge power level as follows:

Estimated Charge Power Level=Estimated Electric Power Decrement−Currently Consumed Power Level.

The vehicle control module 110 receives a maximum rechargeable power level of the battery pack 190 from the battery management system 180 (S350). The maximum rechargeable power level of the battery pack 190 is changed based on a charged power quantity within the battery or the lifespan of the battery. Therefore, the vehicle control module 110 receives the maximum rechargeable power level of the battery pack 190 that is measured in real time.

The vehicle control module 110 compares the estimated charge power level with the maximum rechargeable power level (S360). The vehicle control module 110 judges whether or not the estimated charge power level is greater than the maximum rechargeable power level.

If the estimated charge power level is greater than the maximum rechargeable power level, the vehicle control module 110 calculates a possible maximum torque value to output the possible maximum torque value to the motor control unit 150 (S370). More specifically, if the estimated charge power level is greater than the maximum rechargeable power level of the battery pack 190, the motor control unit 150 calculates the possible maximum torque value from the maximum rechargeable power level in reverse order of the above described calculation.

This is as follows:

Possible Electric Power Decrement=Maximum Rechargeable Power Level+Currently Consumed Power Level

Possible Mechanical Power Decrement=Possible Electric Power Decrement*Efficiency

Possible Maximum Torque=Currently Applied Torque−{Possible Mechanical Power Decrement/(0.1047*Motor RPM)}

The vehicle control module 110 outputs the calculated possible maximum torque value to the motor control unit 150, and the motor control unit 150 controls the motor 160 such that the motor 160 is driven by the possible maximum torque value. In this case, the output of the motor may be reduced as much as the driver operates the brake, and causes change only in the charged power quantity within the battery pack 190.

If the estimated charge power level is equal to or lower than the maximum rechargeable power level, the vehicle control module 110 outputs the request torque value to the motor control unit 150 (S380). The motor control unit 150 controls the motor 160 such that the motor 160 is driven by the request torque value and the battery pack 190 is charged with electric power of the motor.

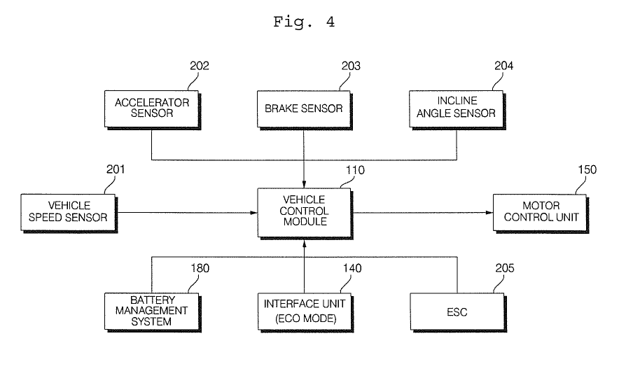

A further embodiment of the present invention in which the motor is controlled based on a calculated torque value. FIG. 4 is a block diagram illustrating a control configuration of the electric vehicle according to a further embodiment of the present invention.

The above described vehicle control module 110 of FIG. 1 is adapted to calculate a torque value and apply the calculated torque value to the motor control unit 150. In the present embodiment, as shown in FIG. 4, the vehicle control module 110 calculates a torque value based on a variety of input values.

In this case, the vehicle control module 110 does not simply calculate a torque value, and may correct the calculated torque value to apply a resulting final torque value to the motor control unit 150.

The vehicle control module 110 is adapted to receive measured values from a vehicle speed sensor 201, an accelerator sensor 202, a brake sensor 203, and an inclination angle sensor 204.

Also, the vehicle control module 110 is adapted to receive information on the state of charge (SOC) of the battery, i.e. a residual power quantity and voltage of the battery from the battery management system 180, and a preset value or information on whether or not an economical (ECO) mode is set from the interface unit 140. The vehicle control module 110 is also adapted to receive data from an electronic stability Controller (ESC) 205.

In this way, the vehicle control module 110 may calculate a torque value using the above described various input data and a current torque value. It is noted that the vehicle control module primarily calculates a basic torque value, and secondarily calculates a final torque value by correcting the primarily calculated torque value based on the input data, rather than using all the aforementioned data from the beginning.

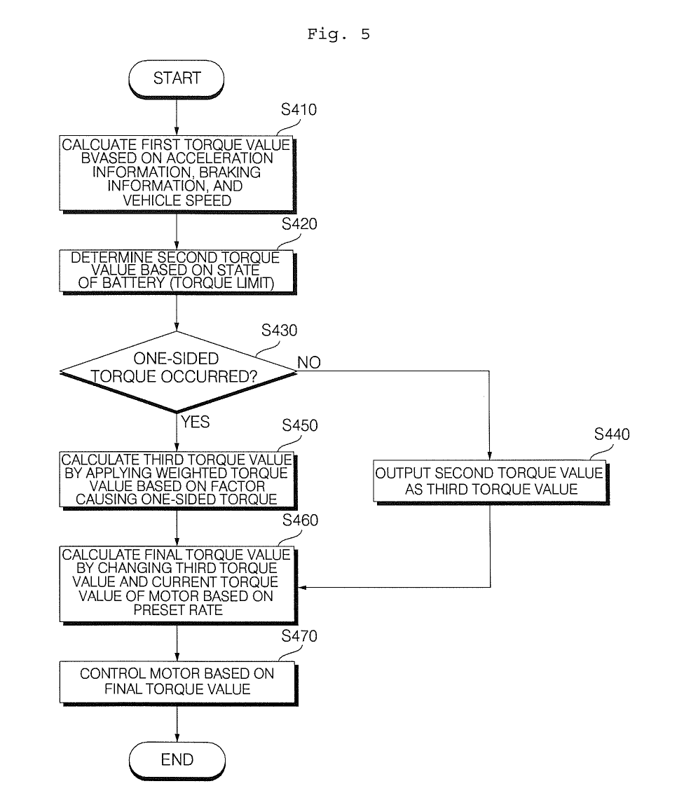

FIG. 5 is a flowchart illustrating a control method of the electric vehicle in FIG. 4.

The vehicle control module 110 calculates a first torque value based on a vehicle speed input from the vehicle speed sensor 201, acceleration information input from the accelerator sensor 202, and braking information input from the brake sensor 203 (S410).

In this case, the first torque value corresponds to a driver request torque value. Since the accelerator and the brake are operated by the driver and the vehicle speed is changed by operation of the accelerator and the brake, the calculated first torque value is the driver request torque value.

Upon calculation of the first torque value, the vehicle control module 110 may calculate the first torque value based on a gear position of the interface unit 140 as well as the acceleration information, the braking information and the vehicle speed. For example, if the gear position is set to any one of a drive mode, a backing mode, and a braking mode, the vehicle control module 110 may calculate the first torque value by reflecting the gear position.

Also, upon calculation of the first torque value, the vehicle control module 110 may calculate the first torque value by applying the acceleration information, the braking information, and the vehicle speed to a preset torque map. In this case, the torque map is a vehicular torque control record, and includes recorded data with respect to torque control that is changed based on the acceleration information, the braking information, the vehicle speed, battery information, and the like.

The vehicle control module 110 may calculate limit values of maximum power that is available based on the state of charge of the battery (SOC), such as the residual power quantity and voltage of the battery input from the battery management system 180.

In this case, the vehicle control module 110 sets upper and lower limits of the maximum power depending on the residual power quantity and voltage of the battery. Here, the lower limit is an allowable minimum torque value and the upper limit is an allowable maximum torque value within a range of ensuring stable output of the maximum torque.

The vehicle control module 110 calculates a corrected second torque value using the preset limit values and the first torque value (S420).

Specifically, the vehicle control module 110 judges whether or not the first torque value deviates from the range of the limit values. If the first torque value deviates from the range of the limit values, it is necessary to calculate a second torque value within the range of the limit values. If the first torque value is within the range of the limit values, the second torque value is directly obtained from the first torque value without correction.

That is, the torque value is limited based on a result of judging whether or not the first torque value, corresponding to the driver request torque value, can be output in a current battery state.

In this case, the vehicle control module 110 judges based on a plurality of input data whether or not one-sided torque output occurs (S430).

If the one-sided torque output does not occur, a third torque value is directly output from the second torque value (S440).

On the other hand, if the one-sided torque output occurs, the third torque value is calculated by correcting the second torque value using a weighted torque value (S450).

Here, the vehicle control module 110 judges that the one-sided torque output occurs if a sensor value is input from the incline angle sensor 204, i.e. the vehicle is located on an incline, if correction based on the SOC value is necessary, if the ECO mode is set, and/or if an input value from the ESC 205 is present.

If the vehicle is located on the incline, and thus the sensor value by the incline angle sensor is input, the vehicle control module 110 corrects the second torque value by applying a weighted torque value based on the sensor value from the incline angle sensor, to calculate the third torque value.

Also, the vehicle control module 110 may correct the second torque value by applying a weighted torque value based on the SOC value input from the battery management system 180, to calculate the third torque value.

For example, if the SOC value represents a small charged power quantity with the battery, the vehicle control module 110 may calculate the third torque value by reducing the second torque value.

In this case, the vehicle may further include a separate State of Charge (SOC) sensor. The SOC sensor serves to sense a charged power quantity of the battery that serves as an energy source of the electric vehicle, thereby inputting the sensor value to the vehicle control module 110 or the battery management system 180.

For example, to sense the charged power quantity within the battery, the SOC sensor may measure the internal resistance of the battery when the vehicle is started. When using an electric equivalent model, the battery may be represented by a resistor component and a capacitor component, and the resistor component may be changed in proportion to an aging degree.

If the ECO mode is set by the interface unit 140, the vehicle control module 110 corrects the second torque value by applying a weighted torque value based on the set ECO mode, to calculate the third torque value. For example, if the ECO mode is set, the vehicle control module may calculate the third torque value by reducing the second torque value.

Also, the vehicle control module 110 may correct the second torque value by applying a weighted torque value based on input data from the ESC, to calculate the third torque value.

In this case, the ESC 205 may serve as a sensor to control the orientation of the vehicle. The ESC 205 determines a reference yaw-rate from the vehicle speed and a wheel steering angle, and controls the posture of a vehicle body to prevent over-steer and under-steer during traveling.

Specifically, the ESC 205 may continuously measure the vehicle speed, wheel steering angle, lateral acceleration and yaw-rate during traveling. The ESC may calculate a reference yaw-rate from the vehicle speed and the wheel steering angle. Also, the ESC may collect an actual yaw-rate of the vehicle from a yew-rate sensor that is installed to the vehicle, and judges abnormal rotation (over-steer or under-steer) if the actual yaw-rate deviates from the reference yaw-rate by a predetermined level or more, thereby performing vehicle posture control.

In this way, the vehicle control module 110 may calculate the third torque value by correcting the second torque value using a weighted torque value based on the vehicle posture control using the ESC.

The vehicle control module 110 may correct the second torque value by applying a plurality of weighted torque values based on a plurality of factors causing one-sided torque output. In this case, the weighted torque values are differently set on a per one-sided torque output factor basis. Although the weighted torque values are basically set by manufacturers, setting of the weighted torque values may be changed based on the driver's driving style, specifications of the vehicle, and the like.

The vehicle control module 110 calculates a final torque value using a current torque value that is previously calculated and currently used for motor control and the calculated third torque value (S460).

The vehicle control module 110 may calculate the final torque value by changing the third torque value and the current torque value based on a preset rate. For example, the preset rate may be a slew-rate. The slew-rate refers to a maximum change rate per hour. That is, the slew-rate is the maximum change rate of output voltage or current per hour acquired by the vehicle control module 110. In this case, the maximum change rate of output voltage of the motor per hour may be used.

That is, the vehicle control module 110 may increase a torque change rate, and thus may adjust the change of torque by applying an appropriate slew-rate.

The vehicle control module 110 applies the calculated final torque value to the motor control unit 150, and the motor control unit 150 controls the motor 160 based on the torque value.

In this way, vehicle traveling is performed at a predetermined torque.

Although the embodiments of the present invention have been disclosed for illustrative purposes, those skilled in the art will appreciate that various modifications, additions and substitutions are possible, without departing from the scope and spirit of the invention as disclosed in the accompanying claims.

1. A control method of an electric vehicle, comprising:
calculating an estimated required power level from a request torque value obtained when a driver operates an accelerator and a currently consumed power level discharged from a battery pack to each element of the electric vehicle;
comparing the estimated required power level with a maximum dischargeable power level of the battery pack; and
calculating a possible maximum torque value from the maximum dischargeable power level if the estimated required power level is greater than the maximum dischargeable power level, to drive a motor by the possible maximum torque value.

2. The control method according to claim 1, wherein the estimated required power level is obtained by calculating an estimated mechanical power increment from a difference between the request torque value and a currently applied torque value for driving the motor, converting the estimated mechanical power increment into an estimated electric power increment, and adding the estimated electric power increment to the currently consumed power level.

3. The control method according to claim 2, wherein the currently consumed power level is calculated via multiplication of a voltage value and a current value of the battery pack.

4. The control method according to claim 2, wherein the possible maximum torque value is calculated from a possible mechanical power increment by calculating a possible electric power increment from a difference between the maximum dischargeable power level and the currently consumed power level, and calculating the possible mechanical power increment from the possible electric power increment.

5. The control method according to claim 1, further comprising driving the motor by the request torque value if the estimated required power level is lower than the maximum dischargeable power level.

6. A control method of an electric vehicle, comprising:
calculating an estimated charge power level from a request torque value obtained when a driver operates a brake and a currently consumed power level discharged from a battery pack to each element of the electric vehicle;
comparing the estimated charge power level with a maximum rechargeable power level of the battery pack; and
calculating a possible maximum torque value from the maximum rechargeable power level if the estimated charge power level is greater than the maximum rechargeable power level, to allow a motor to charge the battery pack by the possible maximum torque value.

7. The control method according to claim 6, wherein the estimated charge power level is obtained by calculating an estimated mechanical power decrement from a difference between the request torque value and a currently applied torque value for driving the motor, converting the estimated mechanical power decrement into an estimated electric power decrement, and subtracting the currently consumed power level from the estimated electric power decrement.

8. The control method according to claim 7, wherein the currently consumed power level is calculated via multiplication of a voltage value and a current value of the battery pack.

9. The control method according to claim 7, wherein the possible maximum torque value is calculated from a possible mechanical power decrement by calculating a possible electric power decrement from the sum of the maximum rechargeable power level and the currently consumed power level, and calculating the possible mechanical power decrement from the possible electric power decrement.

10. The control method according to claim 6, further comprising charging the battery pack using the motor by the request torque value if the estimated charge power level is lower than the maximum rechargeable power level.

11. A motor torque control method of an electric vehicle, comprising:
calculating a request torque value based on acceleration information, braking information, and a vehicle speed;
determining an allowable maximum torque value with respect to the request torque value based on a residual power quantity and voltage of a battery;
calculating a corrected torque value by applying a weighted torque value based on an one-side torque output factor to the allowable maximum torque value when one-sided torque output occurs; and
controlling a motor using a final torque value that is calculated by changing the corrected torque value and a current torque value used for motor control based on a preset rate.

12. The motor torque control method according to claim 11, wherein occurrence of the one-sided torque output is judged if the electric vehicle is located on an incline, if correction based on the State of Charge (SOC) of the battery is necessary, if an economic (ECO) mode is set, and/or if input data from an Electronic Stability Controller (ESC) is present, and the corrected torque value is output by applying the weighted torque value based on the one-sided torque output factor to the allowable maximum torque value.

13. The motor torque control method according to claim 11, wherein the final torque value is variably calculated based on the change of torque by applying a slew-rate depending on the output of the motor to the corrected torque value and the current torque value of the motor.

14. The motor torque control method according to claim 11, wherein the allowable maximum torque value is calculated based on the residual power quantity and voltage of the battery, and if the request torque value is greater than the allowable maximum torque value, the allowable maximum torque value is determined as the corrected torque value.

15. An electric vehicle comprising:
an interface unit including an accelerator sensor to output acceleration information as a driver operates an accelerator, and a brake sensor to output braking information as the driver operates a brake;
a battery pack to discharge electric power;
a vehicle control module for calculating an estimated required power level from a request torque value based on the acceleration information and a currently consumed power level discharged from the battery pack, and comparing the estimated required power level with a maximum dischargeable power level of the battery pack; and
a motor to be driven a possible maximum torque value that is calculated from the maximum dischargeable power level by the vehicle control module if the estimated required power level is greater than the maximum dischargeable power level.

16. The electric vehicle according to claim 15,
wherein the vehicle control module limits the request torque value, calculated based on the acceleration information, the braking information, and a vehicle speed, to the possible maximum torque value, and
wherein the vehicle control module judges occurrence of the one-sided torque output if the electric vehicle is located on an incline, if correction based on the State of Charge (SOC) of the battery is necessary, if an economic (ECO) mode is set, and/or if input data from an Electronic Stability Controller (ESC) is present, and calculates a corrected torque value by applying a weighted torque value based on an one-sided torque output factor.

17. The electric vehicle according to claim 16, wherein the vehicle control module calculates a final torque value, which is changed based on the change of torque of the motor, by applying a slew-rate depending on the output of the motor to the corrected torque value and a current torque value of the motor, so as to control the motor based on the final torque value.

18. An electric vehicle comprising:
an interface unit to output braking information as a driver operates a brake;
a battery pack to discharge electric power;
a vehicle control module for calculating an estimated charge power level from a request torque value based on the braking information and a currently consumed power level discharged from the battery pack, and comparing the estimated charge power level with a maximum rechargeable power level of the battery pack; and
a motor to charge the battery pack by a possible maximum torque value that is calculated from the maximum rechargeable power level by the vehicle control module if the estimated charge power level is greater than the maximum rechargeable power level.
